(19) United States
(12) Patent Application Publication
(10) Pub. No.: US 2013/0161520 A1
(43) Pub. Date: Jun. 27, 2013

(54) SYSTEM AND METHOD FOR COLLIMATION IN IMAGING SYSTEMS

(71) Applicant: Floribertus P.M. Heukensfeldt Jansen, Ballston Lake, NY (US)

(72) Inventor: Floribertus P.M. Heukensfeldt Jansen, Ballston Lake, NY (US)

(73) Assignee: General Electric Company, Schenectady, NY (US)

(21) Appl. No.: 13/333,542

(22) Filed: Dec. 21, 2011

(51) Int. Cl. G21K 1/02; B26F 1/00; G02B 27/30

(52) U.S. Cl. 250/363.1; 359/641; 29/600

(57) ABSTRACT

A system and method for collimation in imaging systems are provided. One system includes a collimator a collimator body and at least one set of pinholes within the collimator body defining a cluster of pinholes, wherein bores defining the pinholes within the cluster are aligned to a point in substantially the same direction. Additionally, a spacing between bores is less than four times a diameter of a largest bore.

### BACKGROUND

In Nuclear Medicine (NM) imaging, radiopharmaceuticals are taken internally and then detectors (e.g., gamma cameras), typically mounted on a gantry, capture and form images from the radiation emitted by the radiopharmaceuticals. The NM images primarily show physiological function of, for example, a patient or a portion of a patient being imaged.

Collimation may be used to focus the field of view of the detectors. Different types of collimation are known, for example, different shapes and configurations of collimators are known for use in different types of applications. However, when designing collimators a tradeoff exists between resolution and sensitivity. For example, a high-resolution collimator views a very narrow column of activity from the patient, and therefore provides high spatial resolution, but at a reduced sensitivity. In contrast, a high sensitivity collimator accepts radiation from a wider range of angles, which increases the sensitivity, but reduces resolution. Thus, depending on desired or required imaging characteristics or properties, collimators are designed to provide resolution and sensitivity levels to maximize or optimize imaging based on the desired or required characteristics or properties. However, such designs may perform unsatisfactorily in different applications.

Accordingly, known collimator designs have to compromise sensitivity for resolution, and vice versa. Thus, these designs may lead to less than optimal imaging for a particular application.

### BRIEF DESCRIPTION

In accordance with an embodiment, a collimator is provided. The collimator includes a collimator body and at least one set of pinholes within the collimator body defining a cluster of pinholes, wherein bores defining the pinholes within the cluster are aligned to a point in substantially the same direction. Additionally, a spacing between bores is less than four times a diameter of a largest bore.

In accordance with another embodiment, a nuclear medicine (NM) imaging system is provided that includes a gantry and at least one imaging detector supported on the gantry and configured to rotate about the gantry defining an axis of rotation. The NM imaging system further includes a collimator adjacent to a detecting face of the at least one imaging detector, wherein the collimator has a plurality of sets of pinholes defining clusters of pinholes. The sets of pinholes are spaced apart within the collimator body, wherein bores defining the pinholes within the sets of pinholes are separated by a distance. The bores within each of the sets of pinholes are also aligned along a same field of view. Additionally, an intra-cluster projection overlap is greater than an inter-cluster projection overlap.

In accordance with yet another embodiment, a method for manufacturing a collimator is provided. The method includes providing a collimator body and forming a plurality of sets of pinholes within the collimator body defining clusters of pinholes. The sets of pinholes are spaced apart within the collimator body, wherein bores defining the pinholes within the sets of pinholes are separated by a distance. The bores within each of the sets of pinholes are also aligned along a same field of view. Additionally, an intra-cluster projection overlap is greater than an inter-cluster projection overlap.

### BRIEF DESCRIPTION OF THE DRAWINGS

FIG. 1 is a simplified block schematic diagram of an imaging system in accordance with an embodiment.

FIG. 2 is a plan view of a collimator formed in accordance with an embodiment.

FIGS. 3-6 are cross-sectional views of bores for a collimator formed in accordance with various embodiments.

FIG. 7 is a diagram illustrating sensitivity profiles in accordance with an embodiment.

FIG. 8 is a diagram illustrating projections acquired with a system having detectors with pinhole cluster collimators in accordance with various embodiments.

FIG. 9 is a flowchart of a method for performing imaging in accordance with various embodiments.

FIG. 10 is a perspective view of a Nuclear Medicine (NM) imaging system formed in accordance with various embodiments.

FIG. 11 is a graph of intensity profiles.

### DETAILED DESCRIPTION

The following detailed description of certain embodiments will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors, controllers or memories) may be implemented in a single piece of hardware (e.g., a general purpose signal processor or random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Also as used herein, the phrase “reconstructing an image” is not intended to exclude embodiments in which data representing an image is generated, but a viewable image is not. Therefore, as used herein the term “image” broadly refers to both viewable images and data representing a viewable image. However, many embodiments generate, or are configured to generate, at least one viewable image.

Various embodiments provide systems and methods for collimation in imaging systems, such as diagnostic imaging systems (e.g., Nuclear Medicine (NM) imaging systems). For example, a collimator arrangement may be provided for use in a Single Photon Emission Computed Tomography (SPECT) imaging system. In general, collimator arrangements of various embodiments provide cluster pinhole collimation for sampling of data at different frequencies. By practicing at least one embodiment, increased high frequency sampling of the image space may be provided. At least one technical effect of at least one embodiment is increased spatial resolution without loss of sensitivity.

Various embodiments may be implemented in different types of NM imaging systems having different arrangements and configurations of gamma cameras, for example, different types of SPECT systems. For example, collimators of various embodiments may be implemented with Sodium Iodide (Nal) SPECT cameras or Cadmium Zinc Telluride (CdZnTe or CZT) SPECT cameras, among others. Additionally, the various embodiments may be implemented in connection with other types of NM imaging systems, such as Positron Emission Tomography (PET) systems, as well as with dual-modality imaging systems.

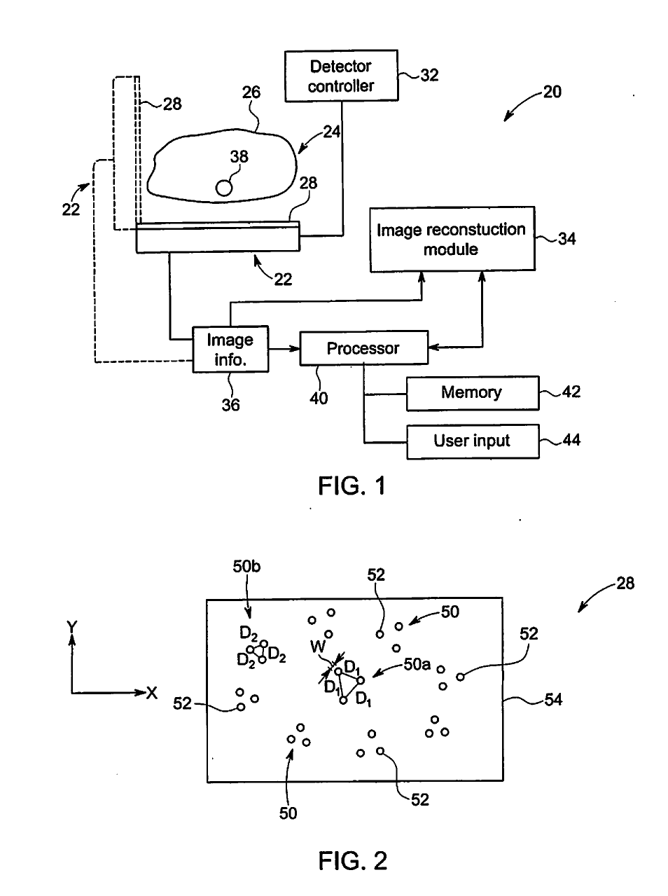

An NM imaging system 20 may be provided as illustrated in FIG. 1 having an NM camera configured as a SPECT detector 22. It should be noted that the various embodiments are not limited to the NM imaging system 20 having a single detector 22 operable to perform SPECT imaging. For example, the NM imaging system 20 may include one or more additional detectors 22 (an additional detector 22 is illustrated in dashed lines) having a central opening 24 therethrough. An object, such as a patient 26, is positioned in proximity to the one or more detectors 22 for imaging.

It should be noted that the number of detectors 22 may be greater than two, for example three or more. In a multi-detector camera, the position of the detectors 22 may be substantially at 90 degrees to each other as illustrated in FIG. 1, or in different configurations as known in the art.

The detectors 22 may be pixelated detectors that may operate, for example, in an event counting mode. The pixelated detectors 22 may be configured to acquire SPECT image data. The detectors 22 may be formed from different materials, particularly semiconductor materials, such as CZT, cadmium telluride (CdTe), and silicon (Si), among others. In some embodiments, a plurality of detector modules is provided, each having a plurality of pixels. In other embodiments, the detector 22 may be made of a scintillation crystal such as Sodium Iodide (NaI) coupled to an array of Photo-Multiplier Tubes (PMTs). However, it should be noted that the various embodiments are not limited to a particular type or configuration of detectors, and any suitable imaging detector may be used.

The detectors 22 include collimators 28 coupled to a detecting face thereof. The collimators in various embodiments are multi-pinhole collimators as described in more detail herein and include one or more clusters of pinholes. In one embodiment, the collimators 28 include clusters of pinholes having long bore channel pinholes.

The detectors 22 may be provided in different configurations, for example, in single planar imaging mode (illustrated in FIG. 1), a two detector 22 “L” mode configuration (illustrated in FIG. 1 with the dashed line detector 22), an “H” mode configuration, or a three headed camera configuration, among others. Additionally, a gantry (not shown) supporting the detectors 22 may be configured in different shapes, for example, as a “C” and the detectors 22 may be arranged in different configurations.

The imaging system 20 also includes a detector controller 32 that operates to control the movement of the detectors 22 around the central opening 24 and about the patient 26. For example, the detector controller 32 may control movement of the detectors 22, such as to rotate the detectors 22 around the patient 26, and which may also include moving the detectors closer or farther from the patient 26 and pivoting the detectors 22.

The imaging system 20 also includes an image reconstruction module 34 configured to generate images from acquired image information 36 received from the detectors 22. In various embodiments, the acquired image information 36 includes an increased high frequency sampling of the image space. For example, the image reconstruction module 34 may operate using NM image reconstruction techniques, such as SPECT image reconstruction techniques to generate SPECT images of the patient 26, which may include an object of interest, such as the heart 38 of the patient.

Variations and modifications to the various embodiments are contemplated. For example, in a dual headed system, namely one with two detectors 22, one detector 22 may include the collimator 28 with cluster pinholes while the other detector 22 includes a parallel hole collimator, a fan beam, collimator, or some other collimator that does not include the cluster pinhole feature.

The image reconstruction module 34 may be implemented in connection with or on a processor 40 (e.g., workstation) that is coupled to the imaging system 20. Optionally, the image reconstruction module 34 may be implemented as a module or device that is coupled to or installed in the processor 40. Accordingly, the image reconstruction module 34 may be implemented in software, hardware or a combination thereof. In one embodiment, the image reconstruction may be performed on a remote workstation (e.g., a viewing and processing terminal) having the processing components and not at the imaging scanner.

The image information 36 received by the processor 40 may be stored for a short term (e.g., during processing) or for a long term (e.g., for later offline retrieval) in a memory 42. The memory 42 may be any type of data storage device, which may also store databases of information. The memory 42 may be separate from or form part of the processor 40. A user input 44, which may include a user interface selection device, such as a computer mouse, trackball, touch interface and/or keyboard is also provided to receive a user input.

Thus, during operation, the output from the detectors 22, which includes the image information 36, such as projection data from a plurality of detectors or gantry angles is transmitted to the processor 40 and the image reconstruction module 34 for reconstruction and formation of one or more images. In one embodiment, the reconstruction of image projections acquired by the detectors 22 includes using a system matrix determined for the collimator 28 by mapping the visibility of each voxel at different detector pixels for each of the collimator apertures (or bores), for example, as described in U.S. Pat. No. 7,829,856, which is commonly owned. However, any suitable reconstruction method may be used.

In one embodiment, the collimator 28 includes a plurality of clusters of pinholes as illustrated in FIG. 2. In particular, sets of clusters 50 of pinholes 52 are provided at different positions of a body 54 (e.g., lead body) of the collimator 28. The pinholes 52 are defined by bores through the body 54 between a front surface facing the patient 24 (shown in FIG. 1) and a back surface having the components and electronics for processing received emissions (e.g., gamma radiation) emitted from the patient 24 who has been injected with a radiopharmaceutical. It should be noted that the bores may be any shape and are not limited to circular bores (e.g., having a circular cross-section), but may be non-circular bores or any arbitrary shape. Additionally, the number of bores within each set and the number of sets are shown merely for illustration. Thus, more of les bores and/or sets of pinholes 52 may be provided, including one set of pinholes 52 or more.

In the illustrated embodiment, each cluster 50 of pinholes 52 includes three separate pinholes 52 arranged in a generally triangular pattern to define a triplet pattern. However, the number and pattern of the pinholes 52 is not limited to the arrangement shown, but may be modified as desired or needed. For example, additional or fewer pinholes 52 may be provided in each cluster 50. Also, the pinholes 52 may be arranged in different orientations and positions with respect to each other.

In one embodiment, the pinholes 52 within different clusters 50, for example, within at least two of the different clusters 50 have spacing between the pinholes 52 that are different and/or have a different rotation or orientation with respect to the x and y axes of the body 54. For example, a pattern of at least one set of the pinholes 52 has a different orientation (e.g., rotation) than a pattern of at least another set of the pinholes 52 relative to the collimator body. Additionally, the spacing between each of the pinholes 52 within a single cluster 50 may be the same or different.

For example, and with reference to the clusters 50a and 50b, the distance between each of the pinholes 52 in cluster 50a is D₁ and the distance between each of the pinholes 52 is cluster 50 b is D₂. In this embodiment, D₁ is not equal to D₂. In the illustrated embodiment, the distance D₁ is greater than D₂ such that the cluster 50a defines a larger triangular area than the cluster 50b. In one embodiment, the distance between the pinholes 52, including the distances D₁ and D₂ are about two diameters of the width (W) of the openings defining the pinholes 52. However, greater or lesser distances may be provided, for example, 1.5 diameters, 3 diameters or 4 diameters, among others. It should be noted that the openings defining the pinholes 52, in particular, the width of the openings, may be the same or different within each cluster 50 and also may be the same or different in different clusters 50.

In some embodiments, each set of pinholes 52 includes at least two bores, wherein the bores are spaced apart by a distance of, for example, between about 1.5 diameters of a bore to about 4 diameters of the bores. In various embodiments, the distance between the edges of adjacent pinholes 52 is, for example, about 4 millimeters (mm) with the diameter of each pinhole 52 being about 6 mm. Thus, the distance between the centers of two pinholes 52 in this embodiment is about 10 mm.

Additionally, in various embodiments the distance between clusters 50 is greater than the distance between the pinholes 52 in one or more of the clusters 52. For example, in one embodiment, the distance between the clusters 50 is at least twice the distance that is between the pinholes 52 within a particular one (or more) of the clusters 50.

In various embodiments, the bores defining the pinholes 52 within the cluster 50 are aligned to a point in substantially the same direction. Also, a spacing between bores in one embodiment is less than four times a diameter of a largest bore. In some embodiments, pinholes 52 within one cluster are aligned to a point in substantially the same direction and pinholes 52 within another cluster are aligned to a different point in substantially the same direction. In other embodiments, pinholes within one cluster are aligned to a point in substantially the same direction and pinholes within another cluster are aligned to the same point in substantially the same direction (namely two sets of clusters are aligned to the same point, and the pinholes 52 within each set are aligned in substantially the same direction, which may be the same or different for each of the clusters). In still other embodiments, pinholes 52 within one cluster are aligned to a point in substantially the same direction, pinholes 52 within another cluster are aligned to the point in substantially the same direction, and pinholes 52 within yet another cluster are aligned to a different point in substantially the same direction.

Moreover, although the pinholes 52 within each cluster 50 are shown as equally spaced, at least two pinholes 52 may be unequally spaced. Additionally, only the clusters 50a and 50b are described for simplicity, but the other clusters 50 may have pinholes 52 with the same or different spacing than the clusters 50a and 50b.

Also, as can be seen in FIG. 2, a plurality of the different clusters 50, including the clusters 50a and 50b are rotated with respect to each other. In particular, the orientation of the pinholes 52 in each of the clusters 50 are not aligned in the x and y directions. Accordingly, the triangular patterns of clusters 50 as shown in FIG. 2 have vertices pointing in different directions.

In various embodiments, the spacing between the pinholes 52 and the rotation of the clusters 50 may be randomly variable (e.g., not based on a particular relationship) or may vary by defined amounts. In the illustrated embodiments, the spacing and rotation are random and do not have a relationship to one another. Also, the positioning of the clusters 50 within the body 54 may be randomly varied or may vary by defined amounts. Thus, the spacing between each of the clusters 50 may be the same or different. As used herein, randomly varying generally means that the spacing varies arbitrarily. By spacing and/or rotating the clusters 50 differently, when reconstructing an image, different frequencies are sampled by the different sets of clusters 50.

Also, although nine clusters 50 are shown, additional or fewer clusters 50 may be provided. The number of clusters 50 provided may be an odd number as shown or an even number. Additionally, although the number of pinholes 52 in each of the clusters 50 is illustrated as the same, the number of pinholes 52 in at least two of the clusters 50 may be different.

It also should be noted that more than one collimator 28 may be provided such as for an array of detectors 22. For example, a plurality of collimators 28 may be provided in connection with a plurality of detectors 22 (e.g., coupled to or adjacent to the detectors 22) each having the collimator body 54. In one embodiment, each collimator body 54 includes a plurality of clusters 50 of pinholes 52. However, in other embodiments, the body 54 may include only a single cluster of pinholes 52 or only a single pinhole 52 (defining a single pinhole collimator). Combinations of collimators 28 also may be provided such that one or more of the bodies 54 have the plurality of clusters 50 of pinholes 52, the single cluster of pinholes 52 and/or only a single pinhole 52.

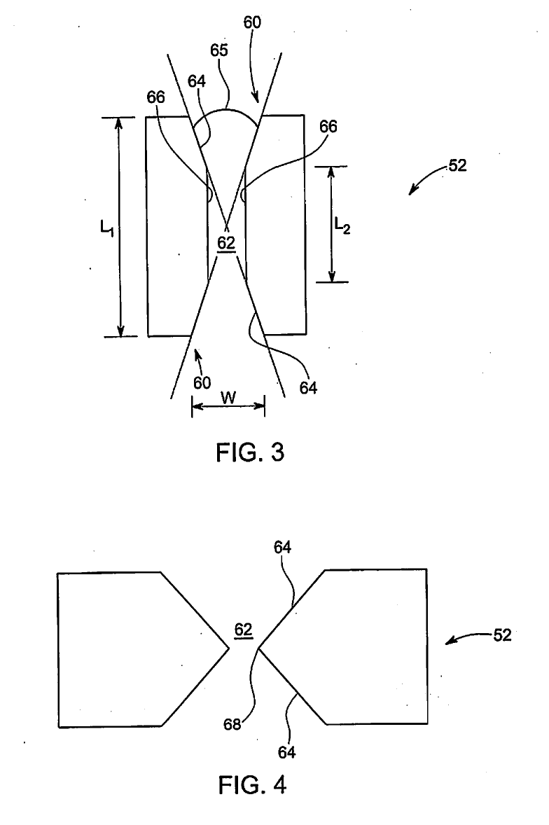

In various embodiments, the pinholes 52 are formed from bores having a sensitivity profile that rolls off with angle such that adjacent clusters 50 have limited overlap in projections. For example, in one embodiment, and as illustrated in FIG. 3, the pinholes 52 (one is shown) are long pinholes having a length L₁ with keel edges 60. In particular, a bore 62 defining the pinhole 52 has parallel walls along a length L₂ with the remaining portion of the overall length L₁ having angled walls 64. Thus, the bores 62 are defined by parallel walls 66 along a middle section and the angled walls 64 along ends thereof. It should be noted that the length L₂ of the middle section and the length of the angled walls 64 may be varied. Additionally, the angle or slope of the angled walls 64 may be varied. In one embodiment, the length L₁ is about 4 times the width W of the opening at the ends of the bore 62 and the length L₂ of the parallel walls is about one-half the length L₁.

It should be noted that variations and modifications are contemplated. For example, in one embodiment, the angled section 64 of the keel edge pinhole may be removed such that the parallel walls 66 extend along the entire length L₁. Also, the length of the angled sections 64 and parallel walls 66 may be varied, including the relative lengths thereof One embodiment of a multi-pinhole cluster collimator has pinholes 52 with long narrow openings, which in this embodiment has an aspect ratio of length/diameter of greater than one or about one. However, the ratio may be varied. Additionally, the bores 62 in various embodiments have a cutoff angle 65 that is about 90 degrees, which is the full angle between rays that are just able to pass the pinhole 52.

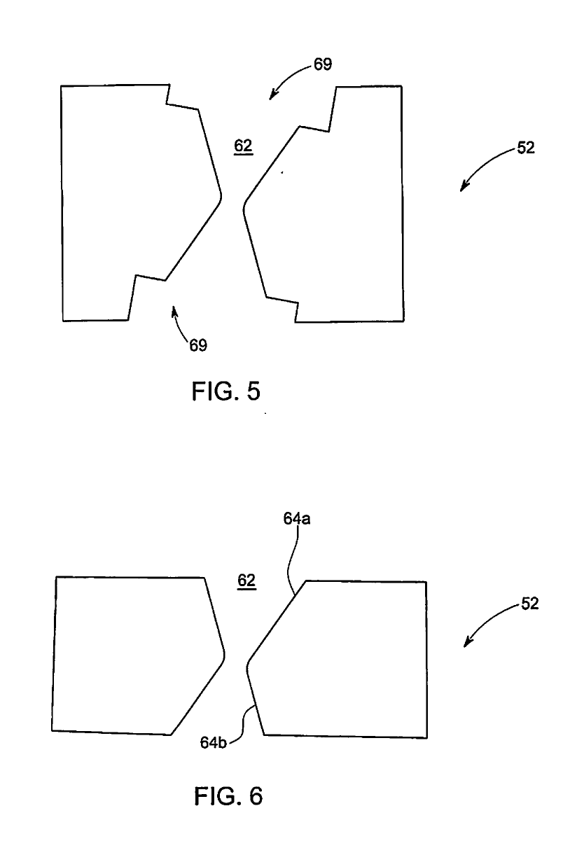

However, it should be appreciated that the pinholes may take different shapes or configurations. For example, as shown in FIG. 4, the pinhole 52 may be a knife edge pinhole having the angled walls 64 that meet at a point or apex 68. As another example, a titled keel edge configuration may be provided as shown in FIG. 5 having a symmetrical cutoff. In particular, the angles walls 64 are titled (compared to FIG. 3), but do not extend to the ends of the bore 62. Instead, cutoff regions 69, which are likewise angled, are provided. The cut-off regions 69 in various embodiments are symmetrical openings that are generally angled and are wider than the gap between the angled walls 64. As still another example, the pinhole 52 may be titled keel edge configuration as shown in FIG. 6 having an asymmetrical cut-off. Thus, unlike the cut-off regions 69 of FIG. 5, the cut-off regions 71 are asymmetrical such that the angled walls 64 (illustrated as 64a and 64b) have different slope angles along different portions of the pinhole 52.

It should be noted that the different configurations of pinholes 52 may be formed using any suitable process. For example, in one embodiment, a pilot hole is initially drilled into a piece of collimator material (e.g., a lead block). Thereafter, the hole forming the bore 62 is formed using a counter bore with a conical bit. It should be noted that in the embodiments having symmetrical holes, a counter bore with an end mill may be used. Then, the central hole of the pinhole 52 is reamed to a desired or required diameter.

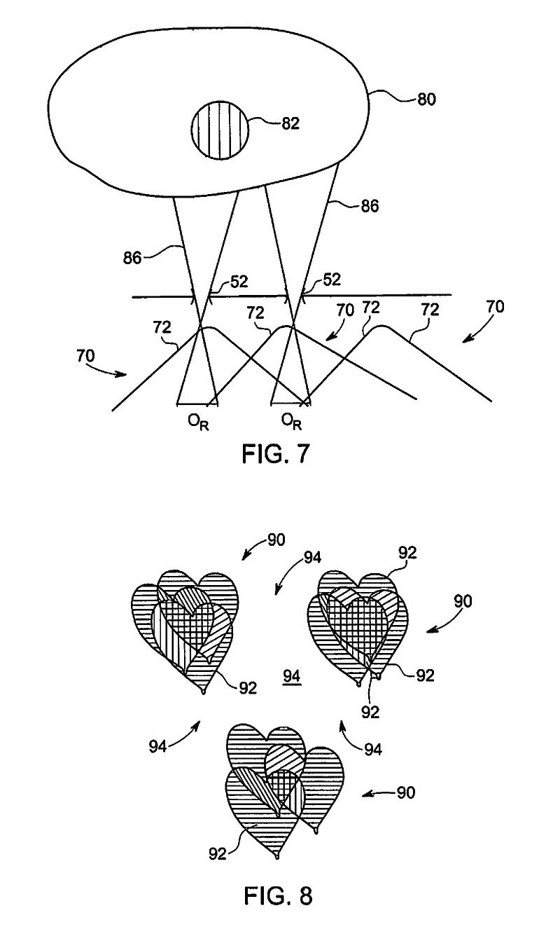

Accordingly, in various embodiments, the pinholes 52 have sensitivity profiles as shown in FIG. 7. In particular, the sensitivity profiles of the pinholes 52 have sensitivity curves 70 (three are shown for one cluster 50) that have smooth fall off regions 72 (e.g., smooth slopes). As illustrated in FIG. 7, projections 86 from a source 82 within an object 80 (e.g., a hotspot within an organ of a patient) have limited overlap as shown by the lines O_{R}. In particular, the projections 86 passing through the pinholes 52 have limited overlap (e.g., less than twenty percent) in adjacent sensitivity curves 72.

More particularly, FIG. 8 shows three clusters 90 of projections 92 acquired in accordance with various embodiments. It should be noted that the shape of the projections is merely for illustration to indicate that the projections are of a heart. However, the projections that are acquired have a different shape or pattern. As can be seen, the projections 92 in each cluster may have different degrees of overlap and different orientations. Moreover, there is significant overlap of the projections 92 within each cluster 90 (e.g., greater than 50 percent in some clusters 90), but limited overlap in the regions 94 between the clusters 90.

Thus, the projection of the object (e.g., heart) through the pinholes 52 in each cluster 90 results in significant overlap of data in the projection space. At the same time, the overlap of the projection data between the clusters 90 is much less. Accordingly, in various embodiments, the intra-cluster projection overlap is more/greater or significantly more/greater than the inter-cluster projection overlap.

Additionally, in various embodiments, the pinholes 52 are shaped such as to limit the acceptance angle of activity, but the pinholes 52 within the same cluster 90 acquire data from (“see”) substantially the same field of view (FOV). Thus, the pinholes 52 in each cluster 90 are aligned along a same FOV. It should be noted that pinholes from different clusters may acquire data from substantially the same FOV, or from a different FOV, such as based on the desired or require imaging (e.g., a particular imaging scenario or application). For example, while focusing many clusters on a small FOV increases the sampling sensitivity in that FOV, it may be necessary to have a few clusters sample a different (usually wider) FOV to ensure sufficient sampling of the entire image volume to get proper reconstruction of the image data in the highly sampled FOV.

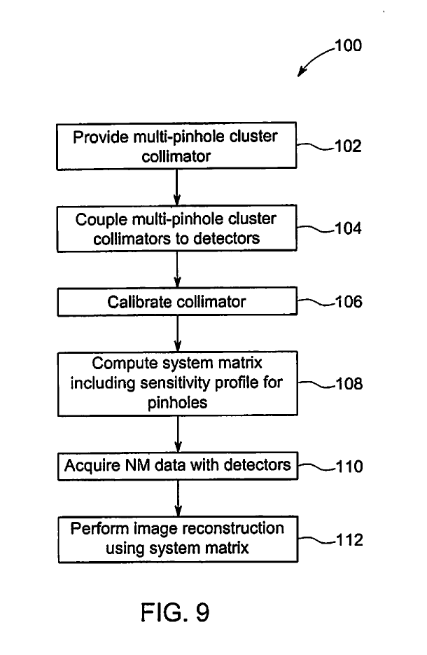

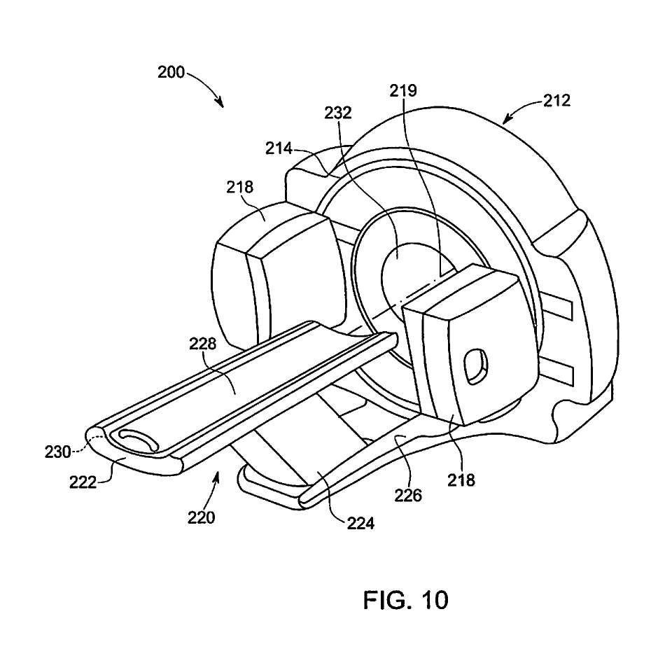

A method 100 for performing NM imaging, such as SPECT imaging, is shown in FIG. 9. The method includes providing a multi-pinhole cluster collimator at 102 and coupling the multi-pinhole cluster collimator to detectors of a NM imaging system at 104. The detectors may be, for example, any type of gamma camera.

As described in more detail herein, the pinholes of the multi-pinhole cluster collimator include clusters of pinholes having long narrow openings (e.g., aspect ratio length/diameter equal to or greater than about 1) that are spaced closer together (e.g., within two diameters) and having two or more pinholes in each cluster. Additionally, some of the clusters have different inter-pinhole spacings and/or orientations.

Thereafter, the collimator is calibrated at 106 to determine the location of the pinholes. The calibration may be performed using any suitable process. For example, multiple point source projections may be acquired and used to compute the exact relationship of the pinholes to the detector and the image space as a function of gantry angle. In one embodiment, this process includes using small fiducial markers (which may be of a different energy than that of the imaging agent, for example, Tc99m if imaging with I-123, or Co-57 if imaging with Tc99m) at different points in the FOV. Based on the imaged location of these markers, the calculation of the exact gantry/detector position is performed. Also, the intensity of the point source projections, and the variation of the intensity as the point source moves in relation to the collimator (or vice versa) can further be used to confirm the exact aperture size and pointing direction of each pinhole. This is done by fitting the known sensitivity profile for a pinhole with arbitrary dimensions to the observed intensities, and solving for parameters such as keel length, bore diameter, and pointing direction.

It should be noted that the fiducial markers may be used when a patient is present (e.g., in the imaging scanner) or when the patient is not present. Accordingly, calibration may be performed with or without the patient in the scanner. For example, with the patient present, the fiducial markers may be used to confirm already determined calibration parameters or to adjust for small errors in detector or gantry position. When the patient is not present, the fiducial markers may be used to perform, for example, system calibration, which may be performed once before installing the imaging system, and then not performed again for a period of time (e.g., during a system maintenance).

The known gantry positions are then used to calculate the corrected system matrix. Specifically, at 108, a system matrix, and in particular the corrected system matrix including the sensitivity profiles are computed for the pinholes. The calculation of the system matrix may be performed using any suitable method. In one embodiment, the system matrix is calculated by determining a point spread function as described in U.S. Pat. 7,829,856.

Thereafter, NM data is acquired by the detectors at 110. For example, SPECT gamma cameras with the multi-pinhole cluster collimators coupled thereto may be rotated about a patient. Using the multi-pinhole cluster collimator different spatial frequencies are sampled by different sets of clusters. It should be noted that the NM data may be data acquired for different types of imaging, for example, cardiac imaging, brain imaging or whole body imaging, among others. While in various embodiments the detectors and/or collimators rotate to multiple positions around the object of interest, it should further be noted that image reconstruction may be performed without rotating the detectors, knowing that the multiple pinholes provide multiple lines of response that can be used to perform image reconstruction.

Image reconstruction is then performed. In particular, image reconstruction using the NM data is performed at 112, which in one embodiment includes using the computed system matrix. For example, an iterative image reconstruction process may be used. However, other image reconstruction methods may be used, such as any suitable image reconstruction method. In some embodiments, a large number of iterations are performed in order to obtain convergence with reduced artifacts, or with no artifacts. For example, in one embodiment, the number of iterations performed is twenty times the number of pinholes in a cluster. The iterative reconstruction results in an image that may be displayed. The reconstruction may also include regularization to prevent excess noise buildup in the image.

The detectors 22 with collimators 28 of the various embodiments may be provided as part of different types of imaging systems, for example, NM imaging systems such as SPECT imaging systems having different detector configurations. For example, FIG. 10 is a perspective view of an exemplary embodiment of a medical imaging system 200 constructed in accordance with various embodiments, which in this embodiment is a SPECT imaging system. The system 210 includes an integrated gantry 212 that further includes a rotor 214 oriented about a gantry central bore 232. The rotor 214 is configured to support one or more NM cameras 218 (two cameras 218 are shown). The NM cameras 218 may be provided similar to the detectors 22 with the collimators 28. It should be noted that the detectors, for example, the detectors 22 or NM cameras 218 are generally equipped with interchangeable collimators. For example, the detector 22 or NM camera 218 is supplied with a plurality of collimators (or collimator pairs for dual head cameras). According to some embodiments, multi-pinhole cluster collimators are supplied with the detector 22 or NM camera 218 to be used for one or more different imaging applications. The multi-pinhole cluster may be configured as described herein and different configurations of the collimator may be chosen to provide optimal imaging for different imaging applications and/or configurations. In some embodiments with more than one detector, the collimator on one or more of the detectors may be a standard collimator, such as a parallel hole or fan beam collimator.

In various embodiments, the cameras 218 may be formed from pixelated detectors or a continuous detector material (e.g., NaI:TI scintillator). The rotors 214 are further configured to rotate axially about an examination axis 219.

A patient table 220 may include a bed 222 slidingly coupled to a bed support system 224, which may be coupled directly to a floor or may be coupled to the gantry 212 through a base 226 coupled to the gantry 212. The bed 222 may include a stretcher 228 slidingly coupled to an upper surface 230 of the bed 222. The patient table 220 is configured to facilitate ingress and egress of a patient (not shown) into an examination position that is substantially aligned with examination axis 219. During an imaging scan, the patient table 220 may be controlled to move the bed 222 and/or stretcher 228 axially into and out of a bore 232. The operation and control of the imaging system 200 may be performed in any suitable manner. It should be noted that the various embodiments may be implemented in connection with imaging systems that include rotating detectors (where a gantry having a stator and a rotor coupled the detectors includes rotation of the stator) or stationary detectors. It should further be noted that the various embodiments may be implemented in connection with imaging systems that include collimators that can move with respect to the detector or detectors, such as described in U.S. Pat. No. 7,671,340 and/or U.S. Pat. No. 7,375,338.

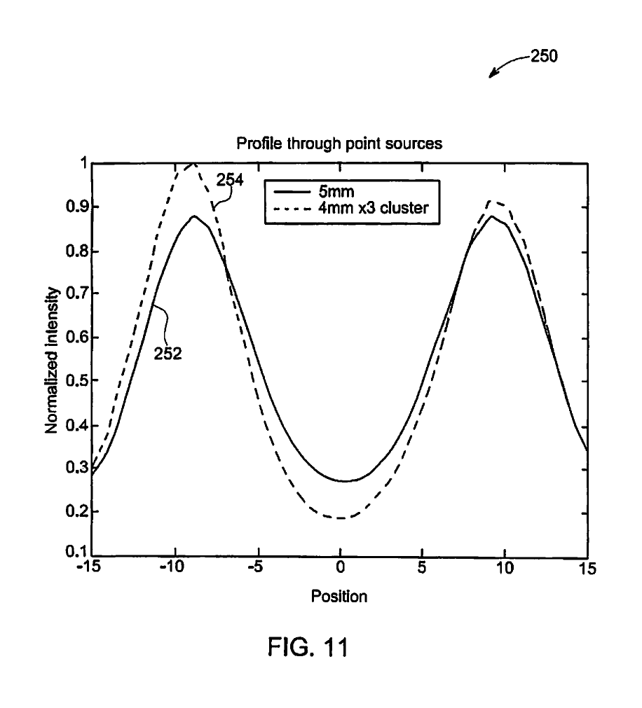

FIG. 11 is a graph 250 showing an intensity profile drawn through part of an image of a resolution phantom, wherein the x-axis represents a position and the y-axis represents a normalized intensity. The phantom has a contrast to background ratio of 10:1, and rods of 6 mm diameter are separated by 12 mm (center to center spacing=18 mm). In this example, the intensity profile for 23 pinholes with 5 mm diameter (corresponding to the curve 252) is compared with the intensity profile for 23 clusters of 4 mm diameter (corresponding to the curve 254). The cluster pinholes resulted in 38% greater sensitivity, while the contrast in the reconstructed image improved by 30%.

The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as an optical disk drive, solid state disk drive (e.g., flash RAM), and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program, which may form part of a tangible non-transitory computer readable medium or media. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

1. A collimator comprising:
a collimator body; and
at least one set of pinholes within the collimator body defining a cluster of pinholes, wherein bores defining the pinholes within the cluster are aligned to a point in substantially the same direction, and wherein a spacing between bores is less than four times a diameter of a largest bore, wherein the set of pinholes is intentionally aligned to have an intra-cluster projection overlap.

2. The collimator of claim 1, further comprising a plurality of sets of pinholes and wherein a distance between sets of pinholes is greater than a distance between pinholes in a set.

3. The collimator of claim 1, further comprising a plurality of sets of pinholes and wherein a pattern of at least one set of the pinholes has a different orientation than a pattern of at least another set of the pinholes relative to the collimator body.

4. The collimator of claim 1, further comprising a plurality of sets of pinholes and wherein the distance between the bores in at least one of the sets of pinholes is different than the distance between the bores in at least one other set of pinholes.

5. The collimator of claim 1, wherein the bores have a cutoff angle of about 90 degrees.

6. The collimator of claim 1, further comprising a plurality of sets of pinholes and wherein each set of pinholes comprises at least two bores, wherein the bores are spaced apart by a distance of between about 1.5 diameters of a bore to about 4 diameters of the bores.

7. The collimator of claim 1, further comprising a plurality of sets of pinholes wherein a spacing between the sets of pinholes varies within the collimator body wherein two sets of pinholes have a different bore spacing therebetween than another two sets of pinholes.

8. The collimator of claim 1, wherein a diameter of the bores in at least one set of pinholes is different than a diameter of the bores in at least one other set of pinholes.

9. The collimator of claim 1, further comprising a plurality of sets of pinholes wherein an intra-cluster projection overlap is significantly greater than an inter-cluster projection overlap.

10. The collimator of claim 1, further comprising a plurality of sets of pinholes wherein pinholes within one cluster are aligned to a point in substantially the same direction and pinholes within another cluster are aligned to a different point in substantially the same direction.

11. The collimator of claim 1, further comprising a plurality of sets of pinholes wherein pinholes within one cluster are aligned to a point in substantially the same direction and pinholes within another cluster are aligned to the point in substantially the same direction.

12. A nuclear medicine (NM) imaging system comprising:
a gantry;
at least one imaging detector supported on the gantry and configured to rotate about the gantry defining an axis of rotation; and
a collimator adjacent to a detecting face of the at least one imaging detector, the collimator having a plurality of sets of pinholes defining clusters of pinholes, the sets of pinholes spaced apart, wherein bores defining the pinholes within the sets are separated by a distance, the bores within each of the sets of pinholes aligned along a same field of view, the sets of pinholes intentionally aligned to have an intra-cluster projection overlap.

13. The NM imaging system of claim 12, wherein at least one set of the pinholes has a different orientation to at least another set of the pinholes.

14. The NM imaging system of claim 12, further comprising a plurality of sets of pinholes and wherein the distance between the bores in at least one of the sets of pinholes is different than the distance between the bores in at least one other set of pinholes.

15. The NM imaging system of claim 12, wherein the bores of the collimator have a cutoff angle of about 90 degrees.

16. The NM imaging system of claim 12, where each set of pinholes of the collimator comprises at least two bores, wherein the bores are spaced apart by a distance of between about 1.5 diameters of the bores and about 4 diameters of the bores, and a diameter of the bores in at least one set of pinholes of the collimator is different than a diameter of the bores in at least one other set of pinholes.

17. The NM imaging system of claim 12, wherein a spacing between the sets of pinholes of the collimator varies within the collimator wherein two sets of pinholes have a different bore spacing therebetween than another two sets of pinholes.

18. The NM imaging system of claim 12, wherein the at least one imaging detector comprises a gamma camera formed from Sodium Iodide (NaI) or Cadmium Zinc Telluride (CZT).

19. The NM imaging system of claim 12, further comprising an image reconstruction module configured to reconstruct an image based on acquired image data received by the at least one imaging detector that includes image voxels, wherein different frequencies are sampled by different sets of pinholes and the reconstruction is performed by mapping a visibility of each image voxel at different pixels of the detector for each of the collimator bores.

20. The NM imaging system of claim 12, further comprising a plurality of collimators adjacent to a detecting face of a plurality of imaging detectors, the plurality of collimators having at least one of a plurality of sets of pinholes or a single set of pinholes.

21. The NM imaging system of claim 20, wherein at least one of the collimators has a single pinhole.

22. A method for manufacturing a collimator, the method comprising:
providing a collimator body; and
forming a plurality of sets of pinholes within the collimator body defining clusters of pinholes, the sets of pinholes spaced apart within the collimator body, wherein bores defining the pinholes within the sets are separated by a distance, the bores within each of the sets of pinholes intentionally aligned along a same field of view such that an intra-cluster projection overlap is significantly greater than an inter-cluster projection overlap.

23. The method of claim 22, wherein, where bores defining the pinholes have an aspect ratio of length/diameter of greater than about 1 and each set of pinholes of the collimator comprises at least two bores such that the bores are spaced apart by a distance of between about 1.5 diameters of the bore and about 4 diameters of the bores.

24. The NM imaging system of claim 12, wherein a distance between edges of adjacent pinholes in each of the respective first and second sets of pinholes have different distances.

25. The NM imaging system of claim 12, wherein the sets of pinholes each have a triangular pattern defining a triplet of pinholes, wherein a first triangular pattern of pinholes has a different orientation or rotation with respect to the x and y axes of a body of the collimator than a second triangular pattern of pinholes.
